(19) United States
(12) Patent Application Publication
(10) Pub. No.: US 2014/0279262 A1
(43) Pub. Date: Sep. 18, 2014

(54) COMPUTER IMPLEMENTED SEARCH SYSTEM

(71) Applicant: Kuyam Companies, Inc., Los Angeles, CA (US)

(72) Inventors: Kourosh Gohar, Los Angeles, CA (US); Tony Rhoton, American Fork, UT (US); Todd M. Zebert, Encino, CA (US); Jackie Chang, Los Angeles, CA (US)

(21) Appl. No.: 13/941,397

(22) Filed: Jul. 12, 2013

Related U.S. Application Data
(63) Continuation-in-part of application No. 13/837,413, filed on Mar. 15, 2013.
Application No. 13/837,413 is a continuation-in-part of application No. 13/872,023, filed on Apr. 26, 2013.

(51) Int. Cl. G06Q 30/06

(52) U.S. Cl. CPC G06Q 30/0627
USPC 705/26.63

(57) ABSTRACT

A computer implemented method of booking an appointment for services desired by a user comprising compiling a database of companies available for the user to search, the database comprising a profile about each company, including the category of services, the location of the company and the available appointments for the services, a search platform accessible by a user operating a computer or a mobile device, the platform allowing the user to search by a category of service, name of a company, location, or date and time available for an appointment, the platform comprising a chat option whereby the user can contact a platform agent to arrange an available appointment with a service company and advise the user of the appointment or the user can activate the chat option for any purpose.

This application is a continuation-in-part application of U.S. patent application Ser. No. 13/872,023 filed Apr. 26, 2013, which is a continuation-in-part application of U.S. patent application Ser. No. 13/837,413 filed Mar. 15, 2013, both of which applications are incorporated herein by reference, in their entireties.

### FIELD OF THE INVENTION

The present invention comprises a platform that acts as a marketplace which empowers its users, the buyers of listed services and its establishments, the sellers of listed services, the capabilities to search, discover, schedule, share and store a user based schedule.

### BACKGROUND OF THE INVENTION

Technology has provided public and private establishments with many means for consumers to schedule appointments. Consumers can make an appointment with an establishment over the phone or via email. Some establishments even offer consumers an option to schedule appointments online by visiting the establishment's website. While technology has made this process easier, consumers who wish to make appointments with multiple establishments have to make several phone calls, and/or log onto several different websites for each establishment. Furthermore, most establishments still lack the means to allow consumers to make appointments online. These limitations waste valuable time and are mistake prone. There is a need to provide consumers with a single integrated platform, a “one stop shop”, which allows consumers to make, modify or cancel online appointments, all on one platform.

There is also a need for a more effective search system that makes it easier for a user to find and learn about companies and businesses and book appointments with them.

### SUMMARY OF THE INVENTION

The invention described herein is an improvement over the system described in the two parent applications referred to above. The improvement adds to the platform described in the parent applications, a “chat” option, in which a consumer, user of the system, can request a chat with a platform agent/administrator, simply by clicking on a chat button on their mobile phone or smart phone or on the platform web site. The consumer, user, may choose to chat for any reason the user feels the need, such as when they are having any sort of problem using the system or because they are booking an appointment with a particular company or type of service, or they want to schedule an appointment through a platform agent. The chat may also be used to modify or cancel an appointment. The platform agent handles customer service and booking.

The inventive system provides means to easily and effectively search using the platform web site or using a mobile phone or smartphone, to find a company for which the user has a need. This can be accomplished using the system search feature to search for a specific category, favorite company and/or previously purchased packages. The search can also be made by selecting category icons that represent the services that the companies offer through the platform.

The search using a mobile phone or smartphone allows the user to search for a company by typing a specific service category or company name or by using a dropdown menu. The search can also be made based upon location using geo-location functions of the mobile device to locate the closest business establishment to the user's mobile device. The search can be directed to the current location or a selected other location or by accessing a previously searched or visited location.

The search can also be based upon a selection of the day and/or time or by selecting a one-click category button which will access the businesses available in the search results. The flexibility of the different search options provides a much better user experience.

The search results will be flexible in that the platform administrator can adjust the search results by enhancing a company's position in the listings based on, for instance, highest user reviews, most available time slots, most appointments booked, and other factors of importance to users.

In addition, the platform has certain features that are available for the user, such as, find and search appointments, review appointment status, history of completed appointments and the ability to review prior receipts for appointment transactions, while also viewing the user's calendar along with any synced third party calendars. Once the user logs into the system there is a dashboard that is present on most all screens that gives quick access to the above mentioned features.

Some of the search features outlined above, as well as the dashboard, may be available only for the users of the platform after a user has signed up and logged onto the platform.

These search features are part of the single platform described in the first parent application which is capable of setting up various appointments with different establishments, described in detail in the parent application. By providing its users with a single platform capable of making appointments with different establishments, this system saves its users time spent on logging onto multiple websites or making several phone calls in order to make appointments with different establishments. The system also creates an online platform to help its users to organize their schedules. The system also allows its users to arrange group meetings, and create or schedule live events using a single integrated platform.

The platform offers its users a convenient method to view the establishments' availability calendar and an option for the user to superimpose the user's own third party calendars (such as Google Calendar, iCal or Facebook events) on top of the establishments' availabilities. The user can also superimpose the establishment's availabilities over the user's own third party calendars. The platform also allows users to book appointments with the establishments directly through the platform. In addition, the platform allows users to create, schedule and initiate events with other users (such as play dates, rideshares, etc.) Also, the user can make an appointment for persons other than themselves, such as their spouse, children, relatives or friends.

It is an object of the present invention to provide an improved search system for the platform which is capable to search, discover, schedule, share and/or store a user based schedule. It is a further object of the present invention to provide its users to be able to search and find one or more establishments that they need and to set up appointments with each establishment, on one calendar.

The description of the platform is described in detail in the parent applications and is incorporated herein by reference, in its entirety.

When a user searches and finds a company or establishment that may provide the needed services, a company profile page for each of the establishments found will be shown, with a built in clock and an integrated calendar. The company profile page includes a calendar with any and all available time slots, associated with specific services and in some cases, a specific employee of the company. In addition to the company's profile page calendar, there is a real world calendar which is divided into months, weeks, days, and may also have an agenda or list format.

The platform contains a function which allows users to search the list of companies for a desired company to make an appointment, and search the list of available time slots of companies to make an appointment. The user can choose to make an appointment with any company on the list of companies by allotting an increment of time in the calendar for the designated company. If a user cannot find the type of company he or she is searching for, the platform contains a feature which allows the user to request that a company be added to the platform.

The platform also contains a feature which allows its users to tag a company as the user's favorite company, resulting in listing the tagged favorite company in the user's “select a favorite” category, with a dropdown button for ease of use.

This system offers its users the opportunity to book an appointment online with any service provider company of choice. Naturally, the appointment needs to be mutually accepted by both the user and the company based on pricing and availabilities.

What makes this platform (known as the kuyam platform) so unique and interesting is that it gives flexibility to both the user and companies. The users get to see a list of availabilities and/or correspond with kuyam agent/administrators to find a time that works for them for any service provider of their choice. The companies get to list their availabilities for booking in multiple options: instantly live, deferred booking (where the company lists its available hours and the user requests an available time) and a kuyam agent connects the information between the user request and the company availabilities.

### The Platform Lists Service Provider Company Availabilities in 4 Different Types:

Company type 1—kuyam instant-book; this is a company that lists its hours on the platform. The user searches a service provider company's available hours and books one from the list of available time slots. The appointment is booked instantly and notices are sent to both the user and the service provider.

Company type 2—kuyam book-it; some of the companies signed up on kuyam's platform do not offer instant booking but offer a deferred process where the user requests a listed timeslot, a kuyam agent (platform agent) reaches out to the company to confirm the availability of the timeslot, and once confirmed, or modified, the booking is passed on to the user;

Company type 3—hybrid-kuyam; for companies that are not kuyam clients but list their availabilities online. This service is offered to kuyam users to provide them with more selections and options even though kuyam may not get compensated for the booking of the appointment;

Company type 4—non-kuyam; this is for companies that are not kuyam clients, do not offer or list their available services online, and do not list much information about the specifics of their services. Kuyam agents chat both with the user and the service provider, back and forth, until a mutually acceptable appointment is scheduled.

Regardless of whether the company is a kuyam instant book; kuyam book-it; hybrid-kuyam; or non-kuyam, a chat option is also available to the user. With the chat option, the user can bypass the process of looking for an appointment themselves and can start chatting directly with a kuyam agent.

Table 1 and Table 2 below set forth the processing of an appointment depending upon the type of company involved.

TABLE 1

| COMPANY TYPE | KUYAM INSTANT-BOOK | KUYAM BOOK-IT |
|---|---|---|
| Who Manages the Company | Company administrator | Company administrator |
| appointments? | | |
| Booking an Appointment | When the user books an | When the user books an |
| Confirmation Process | appointment, the appointment | appointment, the appointment |
| | is confirmed by the system | is in a pending status, until the |
| | immediately. | company confirms the |
| | | appointment. |
| Method of Payment: is ‘Pay- | Yes, depending on company | Yes, depending on company |
| in-Person’ Allowed? | settings | settings |
| Method of Payment: is | Yes, from user to company; or | Yes, from user to company; or |
| ‘PayPal’ Allowed? | user to kuyam/then kuyam to | user to kuyam/then kuyam to |
| | company | company |
| Sales of Packages Allowed? | Yes | Yes |
| Kuyam Appointment Fees | When the user pays company | When the user pays company |
| | via PayPal kuyam fees are | via PayPal kuyam fees are |
| | collected at the time when | collected at the time when |
| | funds are paid to the company. | funds are paid to the company. |
| | When the user pays company | When the user pays Company |
| | by Pay-in-Person, kuyam fees | by Pay-in-Person, kuyam fees |
| | are collected from the | are collected from the |
| | company's PayPal account on | company's PayPal account on |
| | file. | file. |
| Cancellation Process & Fees | The user can cancel any | The user can cancel any |
| | appointment before the | appointment before the |
| | appointment time. If user pays | appointment time. If user pays |
| | via PayPal, the user will be | via PayPal, the user will be |
| | refunded the amount paid | refunded the amount paid |
| | minus any applicable | minus any applicable |
| | cancellation fees. For both | cancellation fees. For both |
| | PayPal and Pay-in-Person, | PayPal and Pay-in-Person, |
| | kuyam fees are accounted for | kuyam fees are accounted for |
| | as well. | as well. |

TABLE 2

| COMPANY TYPE | HYBRID KUYAM | NON-KUYAM |
|---|---|---|
| Who Manages the Company | Kuyam agent | Kuyam agent |
| appointments? | | |
| Booking an Appointment | When user books an | When user books an |
| Confirmation Process | appointment, a kuyam agent | appointment, a kuyam agent |
| | must use the admin site to | must use the admin site to |
| | “manage company” and | “manage company” and |
| | confirm the appointment. | confirm the appointment. |
| Method of Payment: is ‘Pay- | Yes, depending on company | Yes, depending on company |
| in-Person’ Allowed? | settings | settings |
| Method of Payment: is | Yes, from user to kuyam/then | Yes, from user to kuyam/then |
| ‘PayPal’ Allowed? | kuyam to company. | kuyam to company, |
| Sales of Packages Allowed? | Company policy | Company policy |
| Kuyam Appointment Fees | None | None |
| Cancellation Process & Fees | The user can cancel any | The user can cancel any |
| | appointment before the | appointment before the |
| | appointment time. These | appointment time. These |
| | companies will have a | companies will have a |
| | standard cancellation policy - | standard cancellation policy - |
| | no refund if the user cancels | no refund if the user cancels |
| | an appointment within 24 | an appointment within 24 |
| | hours of appointment start | hours of appointment start |
| | time, (subject to change) | time. (Subject to change) |

The basic steps the user takes are as follows: the user searches for a company he or she may want to book an appointment with; the user selects the company's profile page; depending on the type of company (internally tagged) the user will either be able to click a button to see availabilities and/or begin a chat session with a company agent directly from the company's profile page, with a chat button available on the page.

There are two kinds of chat sessions available to the user: first, a general chat button where the user can ask any question or discuss any concern with a kuyam agent. The second chat type is where the chat button is available on the company profile page, where the user can chat with a kuyam agent to book an appointment with the company.

Chat sessions can cover various processes. A user can be chatting with a kuyam agent that may cover other topics and end up booking an appointment through that process. And/or the user can be in a company profile page and ask for a chat with a kuyam agent that may cover other topics, whether the user ends up booking or not booking an appointment directly with the company.

In addition to chatting between the user and a kuyam agent, SMS and/or instant messaging services can also be used between the user and the kuyam agent; or between a kuyam agent and the company; or between the user/kuyam agent/and the company; and/or between the user and the company directly.

### BRIEF DESCRIPTION OF THE DRAWINGS

FIG. 1 is a diagram illustrating the step by step operation of the platform;

FIG. 2A shows a mobile device search page for certain company profiles;

FIG. 2B shows a mobile device search results page for the 2A company profiles;

FIG. 2C shows a mobile device search page for another company profile;

FIG. 2D shows a mobile device search page for the 2C company profile;

FIG. 3A shows a mobile device chat dealing with a company;

FIG. 3B shows a mobile device checkout summary for the 3A company;

FIG. 4A shows a mobile device with the start of a chat; and,

FIG. 4B shows a chat between a user and a platform agent.

### DETAILED DESCRIPTION

Referring to the drawings, FIG. 1 shows the steps taken to utilize the search system of the invention. Step 1 the user selects a company to book an appointment. Step 2 sets forth four different types of companies, the company selected by the user being one of those four types.

If the company chosen by the user is a type 1 company, Step 3, the user taps the “view 185 availability” button and the availability the availability results are listed.

Step 4 the user taps a desired time. Step 5 the user taps on a preferred calendar and Step 6 the user taps on a preferred service.

Then Step 11 the user is taken to appointment checkout and summary page for that time slot and Step 12 the payment process takes place and Step 13 the appointment is booked for the user for that time slot.

Step 7 if the user does not see a desired time so he or she taps “can't find a time, let's chat” button. Step 8 a chat occurs with a kuyam agent and the kuyam agent finds out the preferred day, time and service.

Step 9 the kuyam agent populates day, time and service for the user to book and if the user is satisfied Step 10 the user taps the “instant book” button to get the proposed day, time and service. The user then moves through Steps 11, 12 and 13.

If the company chosen by the user is a type 2 company, Step 14 the user taps “view availability” button and availability results are listed. Step 15 the user taps a desired time. Step 16 the user is taken to appointment checkout and summary page for that time slot. Step 17 is the payment process. Step 18 the appointment is pending and Step 19 the company confirms the appointment and Step 25 the appointment is booked for the user for that time slot.

If the user does not see a desired time Step 21 the user taps “can't find a time? let's chat” button. Step 22 a chat takes place with the kuyam agent who finds out the preferred day, time and service. Step 23 the kuyam agent populates the day, time and service for the user to book. Step 24, if the user is satisfied the user taps the “book it” button to the proposed day, time and service and the user goes through Steps 16 through 25.

If the company chosen by the user is a type 3 company Step 14 the user taps “view availability” button and availability results are listed. If the user finds and taps a desired time Step 15, Steps 16 through 25 take place. If the user does not see a desired time Step 21 the user taps the “can't find a time? let's chat” button. Step 22 a chat takes place with the kuyam agent who finds out the preferred day, time and service.

Step 23 the kuyam agent populates the day, time and service for the user to book. Step 24, if the user is satisfied the user taps the “book it” button to the proposed day, time and service and the user goes through Steps 16 through 25.

If the company chosen by the user is a type 4 company, Step 26 the user taps the “chat to schedule now” button and goes directly to Step 22 where the user chats with a kuyam agent who finds out the preferred day, time and service. Step 24 if the user is satisfied the user taps the “book it” button to the proposed day, time and service and then the user goes through Steps 16 through 25.

Referring to FIGS. 2A, 2B, 2C and 2D, there is shown the face of a mobile device, a mobile phone or smartphone 100. On the face 100 there is menu 102, a search tab 103, a favorites tab 104, and a live chat button 105.

There is also a clickable company name 106 and a heart 107 to put that company into the favorites list. There is also a series of stars 108 that shows the rating of the company.

There is an information button about the company 110, a description of the company button 112 and reviews of the company 114, as well as the business hours 116, the phone number 118 and the directions 120.

In FIG. 2A, for company profiles 1, 2 and 3, there is a view availability button 122.

FIG. 2B, for company profiles 1, 2 and 3, shows a screen with dates and times available. The days of the week 124, a specific day Monday, July 20, 126 and the name of a service provider, Monica 128.

There are several clickable available times 130 and a scroll 132 for more times.

The user's synced personal calendar shows a morning breakfast 134 and there is also an appointment booked on kuyam for a yoga studio confirmed 136. There is also a personal calendar lunch with Joe 138.

There is a “can't find a time? let's chat button 140.

FIG. 2C for type 4 companies, there is a “chat to schedule now!” button 142. FIG. 2D shows a chat screen 144. The name of the company appears above 145 and a back button appears 146. The kuyam agent said, “hello! how can we help?”. The reply is typed below 148 and a send button 150 to send the message.

In FIG. 3A the chat continues in which the kuyam agent arranges the appointment and advises the user to hit the back button 150 to book the appointment.

FIG. 3B tells the user to confirm the appointment or it will be released 152. The appointment is summarized with the date, time, description of the service, the cost, the name of the service person and the user's name at 154. The total due less any discount codes are set forth at 156 and payment can be made using PayPal 157 or payment can be made in person 158.

FIGS. 4A and 4B show a similar situation but the user is connecting through the Web on a computer. There is shown the computer screen 160, on which appears the company name and address 162, the place to type a message 164 and the send button 166 to send the message.

When the kuyam agent arranges the appointment 170 the details are shown in FIG. 4B, 172. When the appointment details have been populated at 172, the “book it” button 168 can be tapped to proceed with finalizing the booking procedure, as set forth above.

A user of the kuyam platform described herein, may want to schedule an appointment with a company by simply having a chat session with a kuyam agent. The user can access the chat feature to talk to a kuyam agent by tapping a button on their phone or smartphone or on the web site or by using voice recognition and text-to-speech technology, such as is available in today, where the user can make the appointment while driving, walking or sitting, without having to look at or touch their phone. Optionally, another button can be present to initiate voice communication for the user to speak with a kuyam agent.

As an additional feature of the kuyam platform system, the system will locate through GPS technology, such as Google Directions API, the location of the user before the time of the appointment. Knowing the location of the user and the location of the appointment, the system can calculate the time it will take for the user to reach the appointment site. If the system determines that the time is close, the system will send a verbal and/or written message to the user to start heading for the appointment or they will be late.

This kuyam reminder system (called “heads up”) tells the user that they better get started for the appointment or they will be late. The user can turn off this reminder feature if they so desire. The feature can be set up to check on the location of the user several times before the appointment time, for example, starting two hours before the appointment time or the feature can be set up to check when it is one hour or less before the appointment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What we claim is:

1. A computer implemented method of booking an appointment for services desired by a user comprising:
compiling a database of service companies available for the user to search;
the database comprising a profile about each company;
the profile comprising one or more of, the company's category of services provided; the location of the company and the available appointment days and times for providing the services;
providing a platform operable by a computer processor accessible by a user operating a computer or a mobile device;
the platform comprising a chat option whereby the user can contact a platform agent;
the platform allowing the user to search for a service by selecting one or more of a category of service, name of a company, a location, or a date and time available for an appointment;
the user activating the chat option to contact a platform agent who will arrange an available appointment with the service company and advise the user of the confirmed appointment.

2. The method of booking an appointment for services of claim 1 in which the company chosen by the user offers instant booking but does not have an available time for an appointment for the user's needs, the user then activates the chat option requiring the platform agent to arrange the appointment.

3. The method of booking an appointment for services of claim 1 in which the company chosen by the user does not offer instant booking but offers deferred booking requiring the platform agent to confirm the booking.

4. The method of booking an appointment for services of claim 1 in which the company chosen by the user lists their availabilities online and the user activates the chat option to contact a platform agent who will confirm an available appointment with the company and advise the user of the confirmed appointment.

5. The method of booking an appointment for services of claim 1 in which the company chosen by the user does not offer their services online and the user activates the chat option to contact a platform agent who contacts the company and chats with both the user and the company to confirm an available appointment and advises the user of the confirmed appointment.

6. The method of booking an appointment for services of claim 1 in which a user initiates a chat session with a company agent directly from the company profile page, using a chat button on the company profile page.

7. The method of booking an appointment for services of claim 1 in which a user initiates a general chat, using a general chat button, with a platform agent, for any user questions or concerns.

8. The method of booking an appointment for services of claim 1 in which a user can enter into contact with a platform agent using SMS or instant messaging.

9. The method of booking an appointment for services of claim 8 in which SMS or instant messaging are used between the user and the platform agent, between a platform agent and the company, between the user, the platform agent and the company or between the user and the company directly.

10. The method of booking an appointment for services of claim 1 in which the user fails to find a desired appointment time and the user taps the chat button to speak to a platform agent.

11. The method of booking an appointment for services of claim 10 in which the platform agent finds a day and time for an appointment and presents the information to the user and the user can book or not book the appointment.

12. The method of booking an appointment for services of claim 1 in which the user taps the chat button and asks the platform agent to arrange an appointment.

13. The method of booking an appointment for services of claim 1 further comprising an automatic reminder of the appointment in which the platform determines the location of the user and the location of the appointment and determines the time that the user needs to reach the appointment on time and the platform notifies the user that they must get started or they will be late.

14. The method of booking an appointment for services of claim 13 in which the location of the user is determined using GPS technology.

15. The method of booking an appointment for services of claim 14 in which the location of the user is determined using Google Directions API.

16. The method of booking an appointment for services of claim 13 in which the reminder is sent to the user when it is one hour or less before the appointment time.

17. The method of booking an appointment for services of claim 1 in which the communication with the agent is done by voice recognition and text-to-speech technology.

18. The method of booking an appointment for services of claim 1 in which the user activates the chat option to modify or cancel an appointment.
